(19) United States
(12) Patent Application Publication
(10) Pub. No.: US 2023/0417080 A1
(43) Pub. Date: Dec. 28, 2023

(54) ELECTRONIC HANDLE DOOR LOCK EASY TO INSTALL AND USE

(71) Applicant: DONGCHUN HUANG, Quanzhou (CN)

(72) Inventor: DONGCHUN HUANG, Quanzhou (CN)

(21) Appl. No.: 17/884,593

(22) Filed: Aug. 10, 2022

(30) Foreign Application Priority Data
Jun. 28, 2022 (CN) 202221555080.3

(51) Int. Cl. E05B 47/00; E05B 13/00; E05B 15/00

(52) U.S. Cl. CPC E05B 47/0012; E05B 13/005; E05B 15/0033; E05B 2047/0017; E05B 2047/0026; E05B 2047/0058; E05B 2047/0084; E05B 37/0034

(57) ABSTRACT

The present disclosure discloses an electronic handle door lock structurally which includes a rear handle, a front handle, a lock body arranged between the rear handle and the front handle, a clutch rotating rod rotatably arranged at an inner side of the front handle, a control circuit board installed on one side of the front handle, and an linkage square pipe penetrating through one side of the lock body and connected between the rear handle and the front handle, wherein the linkage square pipe is connected with the clutch rotating rod, one side of the front handle is provided with a battery case installing slot, one side of the battery case installing slot is detachably provided with a contact type battery case, and an inner side of one side of the battery case installing slot is provided with an electrically conductive plate electrically connected with the control circuit board.

### CROSS REFERENCE OF RELATED APPLICATIONS

The present application claims priority of Chinese Patent Application No. 202221555080.3, filed on Jun. 28, 2022, the entire contents of which are hereby incorporated by reference.

### TECHNICAL FIELD

The present disclosure relates to an electronic handle door lock easy to install and use, belonging to the technical field of locks.

### BACKGROUND

A door lock is a device used to lock a door to prevent others from opening the door. Many kinds of door locks come into being, and have different requirements in different occasions. With the development of technology, the door locks are becoming more varied, including locks unlocked manually by keys and electronic locks unlocked by electronic signals. With the improvement of the quality of life, the simple fashionable electronic door locks are popularized among more and more people, such that simple electronic handle door locks have become the new favorite of the market. Such simple electronic handle door locks are characterized by small structural spaces. In limited spaces of handles of the simple electronic handle door locks, an electronic unlocking method and a manual key unlocking method are designed, and a power supply method is arranged reasonably. For example, a smart fingerprint lock handle disclosed in Chinese Utility Model application number 201921361392.9 filed by the applicant is mainly locked or unlocked by connecting a front handle with a rear handle through an electromagnetic clutch apparatus, and can be unlocked by the front handle by only giving a fingerprint unlocking signal. However, the electromagnetic clutch apparatus has high requirements on the magnetic strength of the magnet, and occupies a large structural space. A power supply component can be mainly arranged on the rear handle, and a power supply connecting line can be guided to the front handle through a middle portion of an linkage square tube so as to be connected with a control circuit board. In this way, the linkage square tube rotates in a long time, which will easily cause the wear to the power supply connecting line, and brings the inconvenience for the installation. An incorrect installation method may easily cause the head of the power line to fall off. For another example, a novel smart lock disclosed in Chinese Utility Model application number 202022887005.4 filed by the applicant solves the previous handle power supply method and reduces the power supply connecting line, manual unlocking by a key can not performed due to a large space occupied by a clutch structure. Accordingly, the novel smart lock is limited in applications. Moreover, the battery case has an unreasonable structure, which brings the inconvenience for replacing the battery.

### SUMMARY

In view of deficiencies of the prior art, an objective of the present disclosure is to provide an electronic handle door lock easy to install and use, to solve problems mentioned in the background.

In order to achieve the above objective, the present disclosure is achieved by the following technical solution. An electronic handle door lock easy to install and use structurally includes a rear handle, a front handle, a lock body arranged between the rear handle and the front handle, a clutch rotating rod rotatably arranged on an inner side of the front handle, a control circuit board installed on one side of the front handle, and an linkage square tube penetrating through one side of the lock body and connected between the rear handle and the front handle, wherein the linkage square tube is connected with the clutch rotating rod, one side of the front handle is provided with a battery case installing slot, one side of the battery case installing slot is detachably provided with a contact type battery case, an inner side of one side of the battery case installing slot is provided with an electrically conductive plate electrically connected with the control circuit board, the electrically conductive plate can be electrically connected with a positive polarity and a negative polarity of a battery within a battery case, an inner side of the front handle is further provided with a double-clutch lock module, the double-clutch lock module is arranged on one side of a clutch rotating rod, and the double-clutch lock module is electrically connected with the control circuit board via a wire.

Further, the double-clutch lock module includes an electric clutch apparatus and a manual clutch lock cylinder, and latching pins respectively arranged on upper sides of the electric clutch apparatus and the manual clutch lock cylinder, wherein return springs are mounted around the two latching pins, the two latching pins are respectively arranged on one side of the clutch rotating rod, and a front side of the clutch rotating rod is provided with a plurality of latching pin limiting slots matched with the latching pins.

Further, the electric clutch apparatus includes a driving motor, a pushing member and a sliding slot, wherein the latching pins are elastically arranged on one side of the sliding slot through the return springs, the driving motor is arranged at one side of the pushing member, the pushing member is slidably arranged on an inner side of the sliding slot, and a lower side of the pushing member is provided with a limiting slot, an inner side of the limiting slot is engaged with an engaging spring restricting the rotation, and one of the latching pins is elastically arranged on one side of the pushing member by the return spring.

Further, the driving motor is connected to the control circuit board by a wire and controlled by the control circuit board, the driving motor is connected with a rotating shaft by means of a shaft, the rotating shaft is inserted on inner sides of the limiting slot and the engaging spring, two sides of a middle portion of the rotating shaft are laterally fixedly provided with a pin, respectively, and the pins are respectively engaged in gaps on two sides of the engaging spring.

Further, the manual clutch lock cylinder includes a key lock cylinder, wherein a telescopic end of the key lock cylinder is arranged on the front side of the latching pin.

The present disclosure has an ingenious structure and a reasonable arrangement. Since the battery case is installed within the front handle, and is of a contact type connection, the battery is replaced by only pulling the whole battery case out, which brings the convenience for the operation. In addition, such an arrangement method completely separates main components such as a transmission component and a rotating component from a power supply component. In this way, the main components and the power supply component are not mutually influenced in a use process. As a result, the service life of the present disclosure is prolonged. Meanwhile, the present disclosure is relatively stable in use, and brings the convenience for later use and maintenance because a dual-clutch lock module is provided. Compared with the prior art, the present disclosure has a more positive and beneficial use effect.

### BRIEF DESCRIPTION OF THE DRAWINGS

Other features, objectives and advantages of the present disclosure will become more apparent by reading the detailed description of non-limiting embodiments with reference to the following accompanying drawings:

FIG. 1 is a schematic view showing a structure of the present disclosure;

FIG. 2 is a schematic view showing an internal structure of the present disclosure;

FIG. 3 is a schematic view of a structure of a dual-clutch lock module of the present disclosure;

FIG. 4 is a schematic view of a structure of a pushing member of the present disclosure; and

FIG. 5 is a schematic view of a structure of a battery case apparatus of the present disclosure.

In the figures: 1, rear handle; 2, front handle; 21, battery case installing slot; 3, lock body; 4, control circuit board; 41, electrically conductive plate; 5, battery case; 6, dual-clutch lock module; 61, driving motor; 62, rotating shaft; 621, pin; 63, pushing member; 631, magnet; 632, limiting slot; 64, engaging spring, 65, sliding slot; 66, key lock cylinder; 67, latching pin, 68, return spring; 7, linkage square tube; 8, clutch rotating rod; and 81, latching pin limiting slot.

### DESCRIPTION OF THE EMBODIMENTS

In order to make technical means, creation features, achievement objectives and effects of the present disclosure understand easily, the present disclosure will be further described below with reference to specific embodiments.

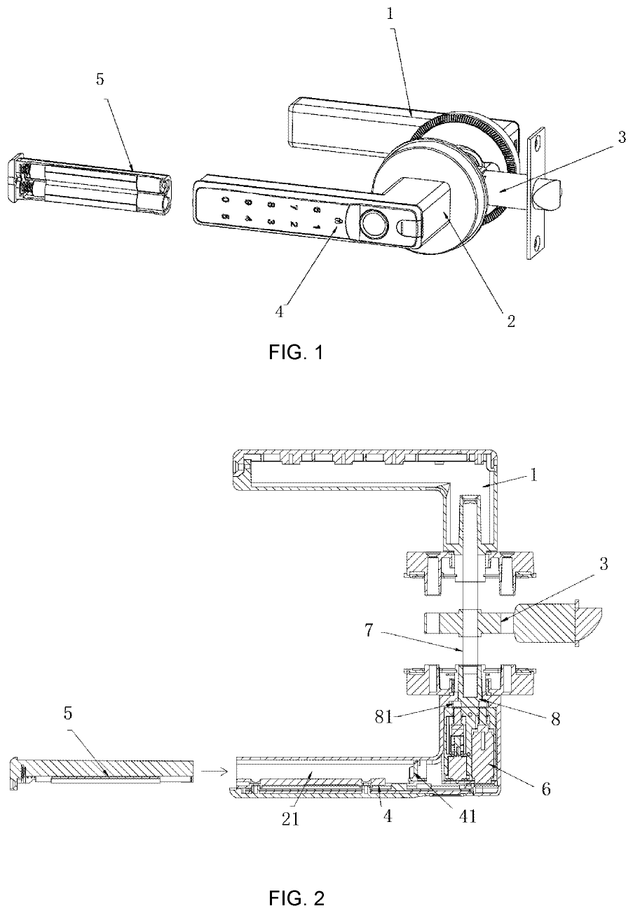

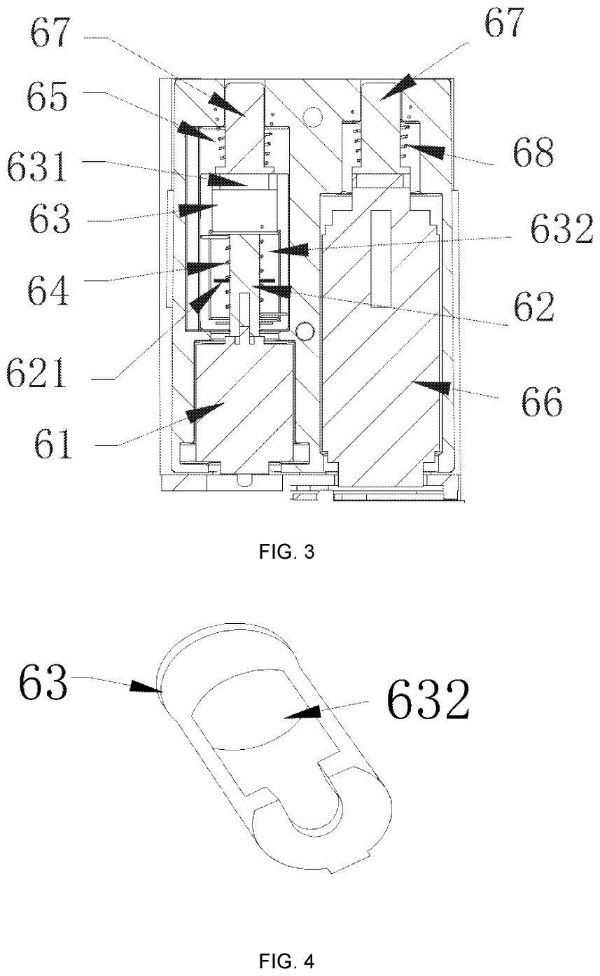

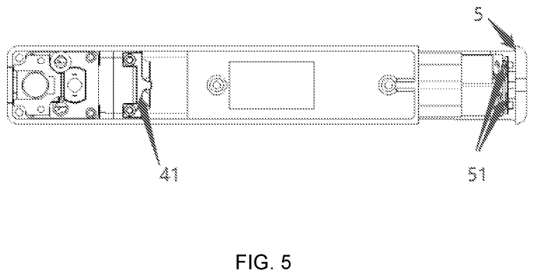

With reference to FIG. 1 to FIG. 4, the present disclosure provides a technical solution of an electronic handle door lock easy to install and use. The electronic handle door lock structurally includes a rear handle 1, a front handle 2, a lock body 3 arranged between the rear handle 1 and the front handle 2, a clutch rotating rod 8 arranged on an inner side of the front handle 2, a control circuit board 4 installed on one side of the front handle 2, and an linkage square tube 7 penetrating through one side of the lock body 3 and connected between the rear handle 1 and the front handle 2. The linkage square tube 7 is connected with the clutch rotating rod 8. One side of the front handle 2 is provided with a battery case installing slot 21. One side of the battery case installing slot 21 is detachably provided with a battery case 5. One end of the contact-type battery case 5 is provided with a spring 51 electrically connected thereto. An inner side of one side of the battery case installing slot 21 is provided with an electrically conductive plate 41 electrically connected with the control circuit board 4. The electrically conductive plate 41 can be electrically connected with a positive polarity and a negative polarity of a battery within a battery case 5. An inner side of the front handle 2 is further provided with a double-clutch lock module 6. The double-clutch lock module 6 is arranged on one side of the clutch rotating rod 8. The double-clutch lock module 6 is electrically connected with the control circuit board 4 via a wire. The dual-clutch lock module 6 includes an electric clutch apparatus and a manual clutch lock cylinder, and latching pins 67 respectively arranged on upper sides of the electric clutch apparatus and the manual clutch lock cylinder. Return springs 68 are mounted around the two latching pins 67. The two latching pins 67 are respectively arranged on one side of the clutch rotating rod 8. A front side of the clutch rotating rod 8 is provided with a plurality of latching pin limiting slots 81 matched with the latching pins 67. The electric clutch lock cylinder includes a driving motor 61, a pushing member 63 and a sliding slot 65. The latching pins 67 are elastically arranged on one side of the sliding slot 65 by the return springs 68. The driving motor 61 is arranged on one side of the pushing member 63. The pushing member 63 is slidably arranged on an inner side of the sliding slot 65. A lower side of the pushing member 63 is provided with a limiting slot 632. An inner side of the limiting slot 632 is engaged with an engaging spring 64 restricting the rotation. One of the latching pins 67 is elastically arranged on one side of the pushing member 63 through the return spring 68. The driving motor is connected to the control circuit board 4 by a wire and controlled by the control circuit board 4. The driving motor 61 is connected with the rotating shaft 62 by means of a shaft. The rotating shaft 62 is inserted on inner sides of the limiting slot 632 and the engaging spring 64. Two ends of a middle portion of the rotating shaft 62 are laterally fixedly provided with a pin 621, respectively, and the pins 621 are respectively engaged in gaps on two sides of the engaging spring 64. The manual clutch lock cylinder includes a key lock cylinder 66. A telescopic end of the key lock cylinder 66 is arranged on the front side of the latching pin 67. One side of the pushing member 63 is provided with a magnet 631 in an embedding manner. The latching pin 67 can be magnetically attracted with the magnet 631.

A working principle of the present disclosure will be described as follows. The battery case 5 of the present disclosure can be directly inserted into the battery case installing slot 21 from one side of the front handle 2 and locked and fixed by a screw. The battery is installed within the battery case 5. The battery is inserted within the battery case installing slot after being placed into the battery case 5. The battery is pushed to the electrically conductive plate 41 under an elastic action of the spring 51. The electrically conductive plate 41 is directly connected with the control circuit plate 41 via a power supply connecting line by respectively connecting a positive polarity contact and a negative polarity contact of the battery with the electrically conductive plate 41 without pulling the power supply connecting line to the rear handle 1. In this way, the wear of the power supply connecting line can be reduced, the service life of the power supply connecting line is prolonged, and the power supply connecting line is conveniently used and replaced. The control circuit board 4 directly controls the driving motor 61 to rotate via a wire. The driving motor 61 drives the rotating shaft 62 to rotate. When the pins 621 on two sides of the rotating shaft rotate, the pins 621 on two ends can rotate along a helical gap of the engaging spring 64, and the engaging spring 64 can deform forwards or backwards, thereby producing a pushing force for pushing the pushing member 63 and the latching pin 67 arranged on one side of the pushing member 63 forwards. The latching pins 67 are directly engaged in the latching pin limiting slot 81 of the clutch rotating rod 8 after being pushed forwards, such that the electronic handle door lock is unlocked by rotating the front handle 2. The electronic handle door lock is convenient and reliable to use. Meanwhile, since the return springs 68 are mounted around the latching pins 67, the pushing member can return under an elastic action of the return springs 68 during retreating.

It should be noted that a head end and a tail end of the engaging spring 64 of the present disclosure extend outwards, such that extending portions of an upper end and a lower end of the engaging spring 64 can be engaged within the limiting slot 632. Moreover, the manual clutch lock cylinder provided is mainly used for backup unlocking. Technical features are relatively common compared with the prior art, and will be omitted in the specification.

The present disclosure is an electronic handle door lock easy to install and use, which is mainly improved over the above structure. Unmentioned functions, components and structures may be implemented by using components and structures capable of realizing corresponding functions in the prior art.

The basic principles and the main features of the present disclosure and the advantages of the present disclosure have been shown and described above. For those skilled in the art, it is apparent that the present disclosure is not limited to details of the above-mentioned exemplary embodiments, and can be implemented in other specific forms without deviating from the spirit or basic features of the present disclosure. Therefore, the embodiments are considered in all respects as exemplary and not restrictive. The scope of the present disclosure is defined by the appended claims rather than the foregoing description, and is therefore intended that all variations falling within the meaning and range of equivalents of claims are embraced within the present disclosure. Any reference signs in the claims shall not be construed as limiting the involved claim.

In addition, it should be understood that although this specification is described in terms of embodiments, not each embodiment only includes one independent technical solution. Such a recitation manner in the specification is only for the sake of clarity. Those skilled in the art should take the specification as a whole, and the technical solutions in the embodiments can be appropriately combined to form other implementations which can be understood by those skilled in the art

What is claimed is:

1. An electronic handle door lock easy to install and use, structurally comprising:
a rear handle (1), a front handle (2), a lock body (3) arranged between the rear handle (1) and the front handle (2), a clutch rotating rod (8) rotatably arranged on an inner side of the front handle (2), a control circuit board (4) installed on one side of the front handle (2), and an linkage square tube (7) penetrating through one side of the lock body (3) and connected between the rear handle (1) and the front handle (2), wherein the linkage square tube (7) is connected with the clutch rotating rod (8), wherein
one side of the front handle (2) is provided with a battery case installing slot (21), one side of the battery case installing slot (21) is detachably provided with a contact type battery case (5), one end of the contact type battery case (5) is provided with a spring (51) electrically connected thereto, an inner side of one side of the battery case installing slot (21) is provided with an electrically conductive plate (41) electrically connected with the control circuit board (4), the electrically conductive plate (41) is capable of being electrically connected with a positive polarity and a negative polarity of the battery within the contact type battery case (5); and
an inner side of the front handle (2) is further provided with a double-clutch lock module (6), the double-clutch lock module (6) is arranged on one side of the clutch rotating rod (8), and the double-clutch lock module (6) is electrically connected with the control circuit board (4) via a wire.

2. The electronic handle door lock easy to install and use according to claim 1, wherein the double-clutch lock module (6) comprises an electric clutch apparatus and a manual clutch lock cylinder, and latching pins (67) respectively arranged on upper sides of the electric clutch apparatus and the manual clutch lock cylinder, wherein return springs (68) are mounted around the two latching pins (67), the two latching pins (67) are respectively arranged on one side of the clutch rotating rod (8), and a front side of the clutch rotating rod (8) is provided with a plurality of latching pin limiting slots (81) matched with the latching pins (67).

3. The electronic handle door lock easy to install and use according to claim 2, wherein the electric clutch apparatus comprises a driving motor (61), a pushing member (63) and a sliding slot (65), wherein the latching pins (67) are elastically arranged on one side of the sliding slot (65) through the return springs (68), the driving motor (61) is arranged at one side of the pushing member (63), the pushing member (63) is slidably arranged on an inner side of the sliding slot, and a lower side of the pushing member (63) is provided with a limiting slot (632), and an inner side of the limiting slot (632) is engaged with an engaging spring (64) restricting the rotation, and one of the latching pins (67) is elastically arranged on one side of the pushing member (63) by the return spring (68).

4. The electronic handle door lock easy to install and use according to claim 3, wherein the driving motor is connected to the control circuit board (4) by a wire and controlled by the control circuit board (4), the driving motor (61) is connected with a rotating shaft (62) by means of a shaft, the rotating shaft (62) is inserted on inner sides of the limiting slot (632) and the engaging spring (64), two sides of a middle portion of the rotating shaft (62) are laterally fixedly provided with a pin (621), respectively, and the pins (621) are engaged in gaps on two sides of the engaging spring (64), respectively.

5. The electronic handle door lock easy to install and use according to claim 4, wherein the manual clutch lock cylinder comprises a key lock cylinder (66), wherein a telescopic end of the key lock cylinder (66) is arranged on the front side of the latching pin (67).
